(19) United States
(12) Patent Application Publication
(10) Pub. No.: US 2024/0023637 A1
(43) Pub. Date: Jan. 25, 2024

(54) NON-COMBUSTIBLE AEROSOL PROVISION SYSTEM

(71) Applicant: Nicoventures Trading Limited, LONDON (GB)

(72) Inventor: Tomi VINTOLA, London (GB)

(21) Appl. No.: 18/041,924

(22) PCT Filed: Aug. 17, 2021
(86) PCT No.: PCT/EP2021/072861

§ 371 Date: Feb. 16, 2023

(30) Foreign Application Priority Data
Aug. 17, 2020 (GB) 2012842.7
Sep. 15, 2020 (GB) 2014515.7

(51) Int. Cl. A24F 40/95; H02J 7/34; H02J 7/00

(52) U.S. Cl. CPC A24F 40/95; H02J 7/342; H02J 7/0045; H02J 7/0048; H02J 7/00712; H02J 7/0013

(57) ABSTRACT

A non-combustible aerosol provision system is described. The non-combustible aerosol provision system includes a non-combustible aerosol provision device and a charging apparatus for use with the non-combustible aerosol provision device. The non-combustible aerosol provision device includes a first rechargeable battery. The charging apparatus includes a housing, a second rechargeable battery disposed within the housing, a first electrical connection port for connecting to the non-combustible aerosol provision device, a second electrical connection port for connecting to an external power source and control circuitry.

### PRIORITY CLAIM

The present application is a National Phase entry of PCT Application No. PCT/EP2021/072861, filed Aug. 17, 2021, which claims priority from GB Application No. 2012842.7, filed Aug. 17, 2020 and from GB Application No. 2014515.7, filed Sep. 15, 2020, each of which hereby fully incorporated herein by reference.

### TECHNICAL FIELD

The present disclosure relates to a non-combustible aerosol provision system comprising a non-combustible aerosol provision device and a charging apparatus for use with the non-combustible aerosol provision device. The present disclosure also relates to a charging apparatus for use with a non-combustible aerosol provision device.

### BACKGROUND

Attempts have been made to provide alternatives to smoking articles such as cigarettes, cigars and the like that burn tobacco during use to create tobacco smoke. Some examples are devices which generate a tobacco flavored aerosols/vapors and/or flavor infused air. Most of these devices include an internal battery to supply energy to various components of the devices, such as heating arrangements and control circuitry. The increased functionalities of these devices are becoming more demanding on the internal battery.

### SUMMARY

According to an aspect of the present disclosure, there is provided a non-combustible aerosol provision system, comprising anon-combustible aerosol provision device and a charging apparatus for use with the non-combustible aerosol provision device, the non-combustible aerosol provision device comprising a first rechargeable battery, the charging apparatus comprising: a housing, a second rechargeable battery disposed within the housing; a first electrical connection port for connecting to the non-combustible aerosol provision device; a second electrical connection port for connecting to an external power source; and control circuitry, wherein, in use, when the external power source is connected to the second electrical connection port and the non-combustible aerosol provision device is connected to the first electrical connection port, the control circuitry prioritizes directing electrical power from the external power source to the non-combustible aerosol provision device to charge the first rechargeable battery over directing electrical power from the external power source to charge the second rechargeable battery.

According to an aspect of the present disclosure, there is provided a charging apparatus for use with a non-combustible aerosol provision device, the charging apparatus comprising: a housing, a rechargeable battery disposed within the housing; a first electrical connection port for connecting to the non-combustible aerosol provision device; a second electrical connection port for connecting to an external power source; and control circuitry, wherein, in use, when the external power source is connected to the second electrical connection port and the non-combustible aerosol provision device is connected to the first electrical connection port, the control circuitry prioritizes directing electrical power from the external power source to the non-combustible aerosol provision device to charge a rechargeable battery of the non-combustible aerosol provision device over directing electrical power from the external power source to charge the re-chargeable battery of the charging apparatus.

According to an aspect of the present disclosure, there is provided a kit of parts comprising the charging apparatus and a non-combustible aerosol provision device for connecting to the first connection port.

Further features and advantages of the disclosure will become apparent from the following description of embodiments of the disclosure, given by way of example only, which is made with reference to the accompanying drawings.

### BRIEF DESCRIPTION OF THE DRAWINGS

FIG. 1 shows a schematic diagram of a non-combustible aerosol provision device.

FIG. 2 shows a schematic diagram of a charging apparatus connected the non-combustible aerosol provision device.

FIG. 3 shows a schematic diagram of a charging apparatus connected to an external power source.

FIG. 4 shows a schematic diagram of a charging apparatus connected to a non-combustible aerosol provision device and an external power source.

FIG. 5 shows a schematic diagram of the charging apparatus in more detail.

FIG. 6 shows a schematic diagram of a charging apparatus according to a second example.

FIG. 7 shows a schematic diagram of a non-power source device.

FIG. 8 shows a circuit diagram of a charging case connected to an aerosol generating device.

### DETAILED DESCRIPTION

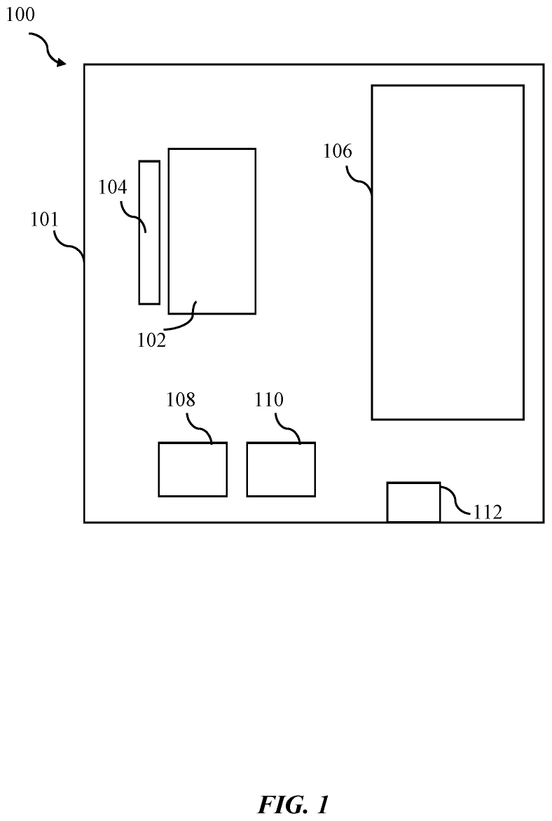

FIG. 1 is a simplified schematic view of a non-combustible aerosol provision device 100. The non-combustible aerosol provision device may comprise part of a non-combustible aerosol generating system.

According to the present disclosure, a “non-combustible” aerosol provision device is one where an aerosol-generating material is not combusted or burned in order to facilitate delivery of at least one substance to a user. In other words, the non-combustible aerosol provision device provides an aerosol without burning or combusting the aerosol-generating material.

In some examples, the non-combustible aerosol provision device is an electronic cigarette, also known as a vaping device or electronic nicotine delivery system (END), although it is noted that the presence of nicotine in the aerosol-generating material is not a requirement. In such examples, the non-combustible aerosol provision device vaporizes an aerosol-generating material in the form of a liquid.

In some examples, the non-combustible aerosol provision device is an aerosol-generating material heating device, also known as a heat-not-burn device, tobacco heating device, etc., as described above. In such examples, the aerosol generating material may not be in liquid form.

In some examples, the non-combustible aerosol provision device is a hybrid device to generate aerosol using a combination of aerosol-generating materials. In some such examples, one or a plurality of the aerosol-generating materials may be heated. Each of the aerosol-generating materials may be, for example, in the form of a solid, liquid, wax or gel and may or may not contain nicotine. In some examples, the hybrid system comprises a liquid or gel aerosol-generating material and a solid aerosol-generating material. The solid aerosol-generating material may comprise, for example, tobacco or a non-tobacco product.

The non-combustible aerosol provision device 100 comprises a housing 101 that houses the various components of the non-combustible aerosol provision device 100. The non-combustible aerosol provision device 100 comprises a chamber 102 configured to receive or contain aerosol generating material (not shown). The aerosol generating material may be comprised in a consumable (not shown).

As used herein, the term aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid. The aerosol-generating material may comprise one or more active substances and/or flavors, one or more aerosol-former materials, and optionally one or more other functional material.

The aerosol-generating material may, for example, include one or more of tobacco, tobacco derivatives, expanded tobacco, reconstituted tobacco or tobacco substitutes. The aerosol-generating material may, for example, be a combination or a blend of materials. The aerosol-generating material may comprise one or more active substances and/or flavors, one or more aerosol-former materials, and optionally one or more other functional material. Aerosol-generating material may also be known as “smokable material”.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theme, vitamins such as B6 or B12 or C, melatonin, cannabinoids, or constituents, derivatives, or combinations thereof. The active substance may comprise one or more constituents, derivatives or extracts of tobacco, cannabis or another botanical.

In some examples, the active substance comprises nicotine. In some examples, the active substance comprises caffeine, melatonin or vitamin B12.

The aerosol-former material may comprise one or more constituents capable of forming an aerosol. In some examples, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, coloring agents, preservatives, binders, fillers, stabilizers, and/or antioxidants.

As used herein, a consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

The non-combustible aerosol provision device 100 comprises an aerosol generator 104 to volatilize at least one component of the aerosolizable material. The non-combustible aerosol provision device 100 is hereafter referred to as the device 100.

As used herein, an aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

In examples in which the aerosol generator 104 is a heater, it may be a resistive heater or an inductive heater, for example. Where an inductive heater is used, the inductive heater generates a varying magnetic field in order to heat one or more susceptor elements. The one or more susceptor elements may or may not form part of the aerosol generator 104 in such examples.

A susceptor material is a material that can be heated by penetration with a varying magnetic field, such as an alternating magnetic field. The susceptor material may be an electrically conductive material, so that penetration thereof with a varying magnetic field causes induction heating of the heating material. The susceptor material may be magnetic material, so that penetration thereof with a varying magnetic field causes magnetic hysteresis heating of the susceptor material. The susceptor may be both electrically conductive and magnetic, so that the susceptor can be heated by both heating mechanisms.

The device 100 comprises a power source 106 located within the housing 101. The power source 106 supplies electrical power to the various components of the device 100 including the aerosol generator 104. The power source 106 comprises a rechargeable battery, for example, a lithium ion battery. The rechargeable battery 106 may comprise a plurality of sub-batteries. In the following examples, the power source 106 is referred to simply as the battery 106.

In the example of FIG. 1, the device 100 comprises control circuitry 108 which is in data communication with a computer readable storage memory 110. The control circuitry 108 is arranged to control the various aspects and operations of the device 100. For example, the control circuitry 108 may control the delivery of electrical power from the battery 106 to the aerosol generator 104. In some examples, the control circuitry 108 comprises a micro-processor or the like and associated circuitry for controlling the functions of the device 100.

In the example of FIG. 1, the device 100 comprises an electrical connection port 112 that is in electrical communication with the control circuitry 108 and the battery 106. Amongst other functions, the electrical connection port 112 facilitates charging of the battery 106 from an external power source (not shown), for example a battery charger or mains supply. In some examples the electrical connection port 112 is an industry standard electrical connection port such as Universal Serial Bus (USB), USB Type C, Micro USB and in other examples the electrical connection port 112 is a proprietary or bespoke connector arrangement. The electrical connection port 112 may also take the form of a wireless receiver so as to permit wireless charging of the battery 106.

It will be appreciated that the device 100 comprises other components not shown in FIG. 1, such as ventilation inlets/outlet, and a control interface. It should be noted that FIG. 1 is merely a schematic sketch showing a number of components that could be included in the device 100. FIG. 1 is not intended to communicate particular positions of various components.

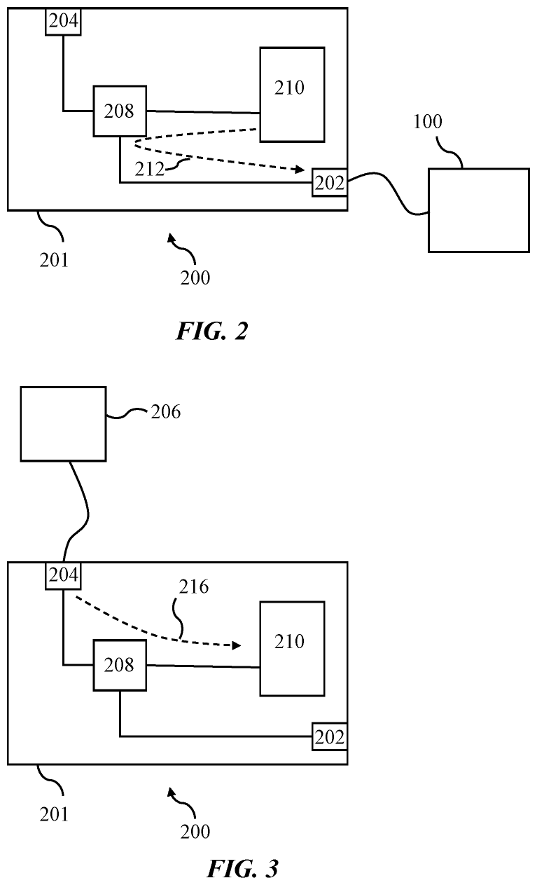

FIGS. 2 to 4 are simplified schematic diagrams of a charging device 200 with various combinations of devices connected thereto according to a first example. The charging device may form part of a non-combustible aerosol generating system, with the device 100. The charging device 200 comprises a housing 201 which contains and protects the various components of the charging device 200 including an internal battery 210. The internal battery 210 is a rechargeable battery, for example, a lithium ion battery. The internal battery 210 may comprise a plurality of sub-batteries.

As will be explained in more detail below, the charging device 200 is connectable to the device 100 in order for the charging device 200 device to provide power to charge the battery 106 of the device 100. When the device 100 is connected to the power provision device 200 and the charging device 200 is not itself connected to an external power supply (e.g. a mains supply), power to recharge the battery 106 of the device 100 is provided from the internal battery 210 of the charging device 200.

The charging device 200 is also connectable to an external power supply 206, for example, a mains supply. When the charging device 200 is connected to the external power supply 206 and the charging device 200 is not also connected to the device 100, the external power supply supplies power to charge the internal battery 210 of the charging device 200 when the internal battery 210 requires recharging.

The charging device 200 is configured so that when the charging device 200 is connected to the external power supply 206 and to the device 100, the charging device 200 prioritizes directing power from the external power supply 206 to charge the battery 106 of the device 100 over directing power from the external power supply 206 to charge the internal battery 210 of the power provision device 200.

In this example, the charging device 200 is in the form of a portable carry case that can be used to store and charge the device 100 while a user of the device 100 is on the move. In effect, this extends the battery life of the device 100 without increasing the size/weight of the device 100 because a user can simply remove the device 100 from the carry case for use. Herein below, the charging device 200 will be referred to as the charging case 200.

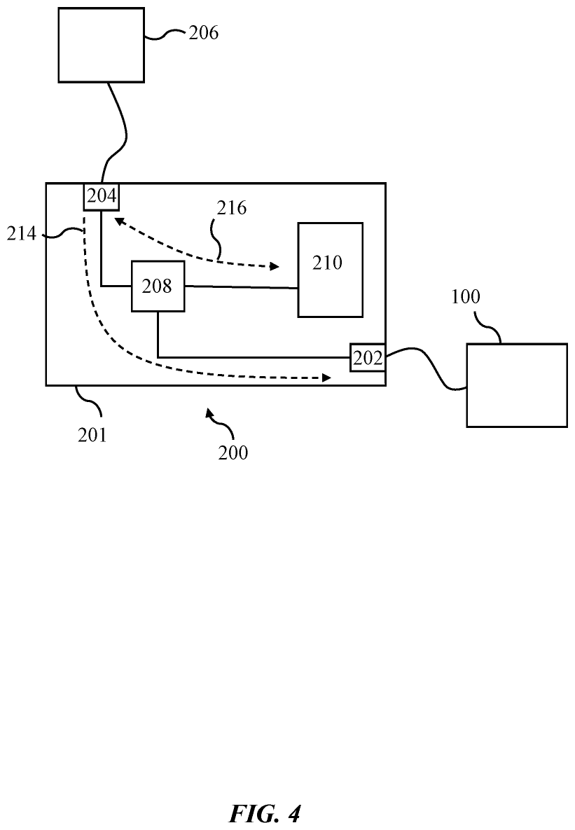

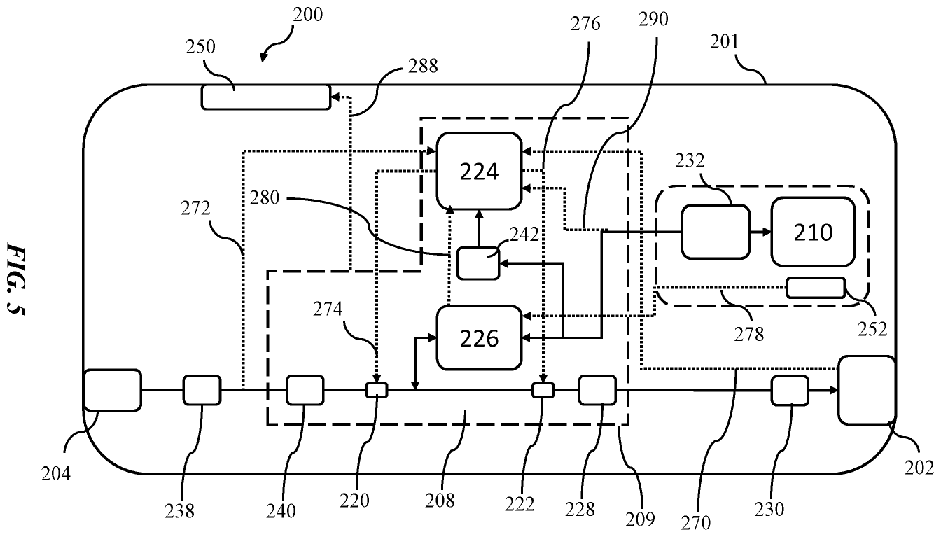

The charging case 200, as is best illustrated in FIGS. 2 and 4, comprises a first connection port 202 for connecting to the connection port 112 of the device 100. The connection may be a direct port to port connection, via a suitably arranged connecting cable or a wireless connection. In some examples, the first connection port 202 is a bespoke (i.e. proprietary) connection port. For example, the first connection port 202 may comprise two pins (e.g. ground and +5V). The advantage of a bespoke connection port 202 is that it permits only certain compatible devices with a corresponding bespoke connection port to removably connect to the charging case 200. For example, only other proprietary devices made by the manufacturer of the charging case 200.

The charging case 200 is arranged so that electrical power can be transferred from or via the charging case 200 through the first connection port 202 to the device 100. The electrical power transferred out of the charging case 200 charges the battery 106 of the device 100.

As is illustrated in FIGS. 3 and 4, the charging case 200 comprises a second connection port 204 for connecting to the external power source 206. Again, the connection may be a direct port to port connection, via a suitably arranged connecting cable or a wireless connection. The second connection port 204 is disposed within the housing 201 of the charging case 200 and provides a second electrical and/or data connection to the charging case 200. In this example, the second connection port 204 is an industry standard electrical connection port, for example, a USB connection port. This allows many different devices types of power sources and/or different types of other devices to be removably connected to the charging case 200. Of course, other examples of bespoke electrical connection sockets or power transfer arrangements could be used.

In some examples, the external power source 206 connects to a source of mains electricity via a wall socket to supply power via a cable that is connected to the second connection port 204. For example, such a power source could be a charger supplied with the charging case 200 or another generic USB charger connected to mains. In alternative examples, the external power source 206 is a power source from another device, for example, a computer, a car (via a car's power outlet socket), solar panel, or the like connected via a cable or wirelessly to the second connection port 204.

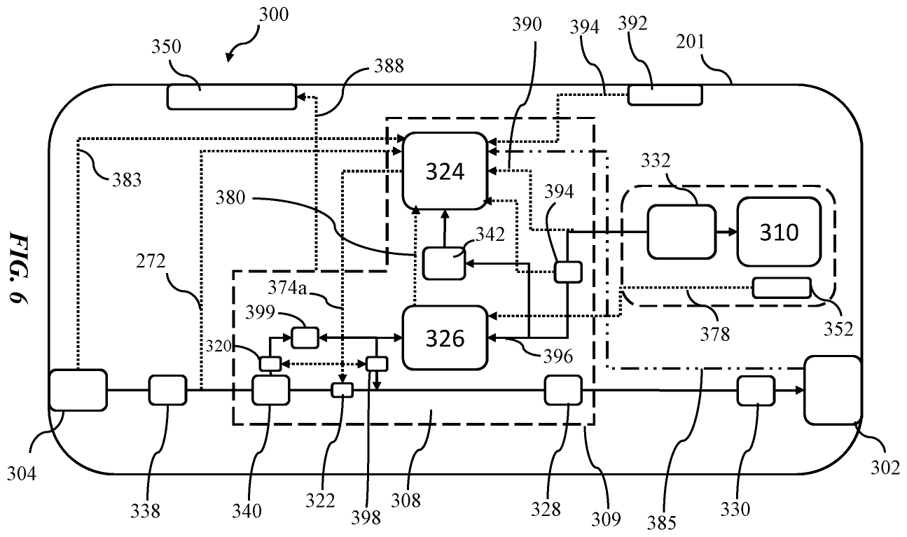

The second connection port 204 is in electrical connection with the first connection port 202 through control circuitry 208. Thus, electrical power supplied from the external power source 206 is transferred via the second connection port 204, the control circuitry 208 and the first connection port 202 to the device 100 as represented by arrow 214 in FIG. 4. Examples of control circuitry 208 are described below in more detail in relation to FIGS. 5 and 6.

The internal battery 210 of the charging case 200 stores electrical power provided from the external power source 206 and is arranged to provide a number of full charges, for example, at least two, to the device 100. The internal battery 210 is in electrical connection to the first connection port 202 and second connection port 204 through the control circuitry 208. The internal battery 210 is chargeable by the external power source 206 when the external power source 206 is connected to the second connection port 204.

As previously mentioned above, the flow of electrical power from the external power source 206 to the internal battery 210 and the device 100 is controlled by the control circuitry 208. In the example of FIG. 2, only the device 100 is connected to the charging case 200, and so electrical power is directed from the internal battery 210 through the first connection port 202 to the device 100 (shown by arrow 212) when the battery 106 of the device 100 requires charging.

In the example of FIG. 3, only the external power source 206 is connected to the charging case 200. Therefore, the control circuitry 208 directs electrical power from the external power source 206 to charge the internal battery 210 (shown by arrow 216) when the internal battery 210 requires charging.

When both the external power source 206 and the device 100 are connected to the charging case 200 (as best seen in FIG. 4) and both the battery 106 of the device 100 and the internal battery 210 of the charging case 200 require charging, the control circuitry 208 prioritizes directing power from the external power source 206 to charge the battery 106 of the device 100 over directing power from the external power source 206 to charge the internal battery 210.

In one example, while the battery 106 of the device 100 is being charged, only if sufficient excess electrical power is available from the external power source 206, will the control circuitry 208 also supply power from the external power source 206 power to charge the internal battery 210 of the charging case 200.

In another example, when the battery 106 of the device 100 becomes fully charged, the control circuitry 208 only then starts to supply electrical power from the external power source 206 to charge the internal battery 210 of the charging case 200.

It will be appreciated that the charging case 200 may comprise other components not shown in FIGS. 2 to 4, such input detectors, charge status indicators, and switches. Moreover, the control unit 208 may comprise other components such as processors, sensors, and voltage regulating circuits. It should be noted that FIGS. 2 to 4 are merely schematic drawings showing a number of components that could be included in the charging case 200 or connected thereto. FIGS. 2 to 4 are not intended to communicate particular positions of various components.

FIG. 5 is a schematic diagram showing the charging case 200 as described in relation to FIGS. 2 to 4 in more detail. In FIG. 5, the solid arrows represent electrical power lines and dashed arrows represent control and/or monitoring lines between various internal components of the charging case 200. As previously described, the charging case 200 comprises the first connection port 202, the second connection port 204, the control circuitry 208 (indicated in FIG. 5 as a dashed box) and the internal battery 210.

In this example, the charging case 200 further comprises a first electro-static discharge protection unit 230 and a second electro-static discharge protection unit 238. The first electro-static discharge unit 230 protects the first connection port 202 from electrostatic discharge and is situated between the first connection port 202 and the control circuitry 208. The second electro-static discharge unit 238 protects the second connection port 204 from electrostatic discharge and is situated between the second connection port 204 and the control circuitry 208. The charging case 200 also comprises one or more indicators 250 to indicate the charge status of the internal battery 210 and/or other information to a user of the charging case 200.

In some examples, the one or more indicators 250 are a set of light emitting diodes (LED) which are in electrical connection with the control circuitry 208 via a control line 288. The LEDs are used to indicate the charge status of the internal battery 210, for example, whether the internal battery 210 is fully charged, partially charged, or fully discharged. In one example, one or more indicators 250 comprise a single RGB LED where the different colors indicate different states of charge of the internal battery 210. In another example, the one or more indicators 250 comprise a plurality of single color LEDs, for example, white LEDs, where the number of LEDs switched on are an indication of the charge status of the internal battery 210. In another example, the one or more indicators 250 indicate that the internal battery 210 is being charged in addition to indicating the charge status. Of course, other indicators such as screens, LCD displays, speakers and the like can equally well be used as to indicate the charge status of the charging case 200.

In this example, the control circuitry 208 is represented by the dashed box 209 which encompasses various components. The control circuitry 208 comprises a micro controller unit (MCU) 224 (for example a model STM32G031G4). The MCU 224 monitors the first connection port 202 via monitoring line 270 and the second connection port 204 via monitoring line 272 to detect if any devices are connected to the charging case 200 and that the first connection port 202 and second connection port 204 are active. Different external power sources supply different voltage levels and the MCU 224 monitors the voltage level on the monitoring line 272 of a power source or device connected to the second connection port 204. The voltage of the internal battery 210 is monitored by the MCU 224 over the monitoring line 290.

The control circuitry 208 further comprises an input voltage protection unit 240 to protect the internal components of the charging case 200 from over voltage and/or reverse voltage conditions. In one example, the charging case 200 can handle a +20V supply from USB type C power sources without damaging the internal components and the input protection unit 240 protects the charging case 200 when non-compliant USB type C chargers are connected. The control circuitry 208 further comprises an output voltage protection unit 228 to protect components of the device 100 when connected to the first connection port 203 from over current conditions.

The control circuitry 208 further comprises a low dropout voltage regulator (LDO) 242 to maintain a constant voltage supply from the internal battery 210 to the MCU 224.

The control circuitry 208 further comprises a charging integrated circuit 226 (charging IC). In this example, the charging IC 226 is a switch mode battery charger, for example, the BQ25303J manufactured by Texas Instruments. The charging IC 226, under the control of the MCU 224, regulates the charging of the internal battery 110 when a power supply is connected to the second connection port 204 and the internal battery 210 is being charged. The charging IC 226 is in connection with the MCU 224 via a suitable control line 280, for example, a Inter-Integrated Circuit I²C serial communication bus.

The charging IC 226 monitors the temperature of the internal battery 210 via a battery temperature monitor line 278 which is connected to a battery temperature sensor 252. The internal battery 210 is protected from overcharging by a battery protection unit 232. In one example, the battery temperature sensor 252 is in thermal contact with the internal battery 210 to provide an accurate temperature reading of the internal battery 210. For example, if while the internal battery 210 is charging, the temperature begins to reach a temperature that is deemed too hot for the internal battery 210, the charging IC 226 will reduce the current supply to the internal battery 210 accordingly. Alternatively, if while the internal battery is 210 is being used to charge the battery 106 of the device 100 that is connected to the first electrical connection port 202, the internal battery 210 temperature is deemed too high, the charging IC 226 reduces the current accordingly, or stops the charging to prevent damage to the internal battery 210. The charging IC 226 may also regulate the supply of electrical power to and from the internal battery 210 if the temperature of the internal battery 210 is too cold or below a certain threshold temperature.

The control circuitry 208 further comprises a first switch 220 and a second switch 222. The MCU 224 controls the first switch 220 via a first switch control line 274 and controls the second switch 222 via a second switch control line 276. As will be explained in more detail below, the MCU 224 directs electrical power between the first connection port 202, the second connection port 204 and the internal battery 210, by controlling the first switch 220 and second switch 222 to either ON or OFF states in various combinations. In one example, the first switch 220 and the second switch 222 are low ohmic Field Effect Transistors (FETs) although other types of switches may also be used.

The operation of the charging case 200, in relation to the configurations shown in FIGS. 2 to 4 and with reference to the components described in FIG. 5, is further described below.

In one example, as shown in FIG. 2, only the device 100 is connected to the charging case 200 and the battery 106 of the device 100 is under charged. In this scenario, the MCU 224 detects via the monitoring line 272 that the device 100 is connected to the charging case 200 through the first connection port 202 and determines via the monitoring line 270 that no power supply or further device is connected to the charging case 200 through the second connection port 204. The MCU 224 configures the first switch 220 via the switch control line 274 to be in an OFF state and the second switch 222 via the switch control line 276 to be in an ON state. Thus, with the switches in this configuration, electrical power is provided from the internal battery 210, via the charging IC 226 and the first connection port 202, to charge the battery 106 of the device 100. No electrical power can flow to the second connection port 204. It will be appreciated that the device 100 will comprise its own charging integrated circuit (not shown) for regulating the charging of the battery 106 of the device 100 when power is provided in this way from the internal battery 210 and so, in these circumstances, the charging of the battery 106 of the device 100, is under the control of the device's 100 own charging integrated circuit (not shown) and not the IC 226. However, in some examples, the IC 226 may convert the voltage of the internal battery 210 to a value that is compliant with the expected charging voltage of the device 100.

As described above, the charging IC 226 monitors the temperature of the internal battery 210 and adjusts the output voltage to the first connection port 202 to prevent the internal battery 210 from overheating and becoming damaged and/or a safety hazard to the user.

In another example, as shown in FIG. 3, only an external power source 206, is connected to the charging device 200 via the second connection port 204 and the internal battery 210 is under charged. In this configuration, the MCU 224 detects via the monitoring line 270 that the external power source 206 is connected to the second connection port 204 and determines from the monitoring line 272 that the device 100 is not connected to the charging case 200 through the first connection port 202. The MCU 224 configures the first switch 220 to be in an ON state and the second switch 222 to be in an OFF state via the switch control lines 274 and 276 respectively. When the first switch 220 and second switch 222 are in this configuration and the internal battery is under charged, electrical power from the external power source 206 is provided via the charging IC 226 to the internal battery 210 to charge the internal battery 210. The internal battery 210 is protected from overcharging by the battery protection unit 232 and the temperature of the battery is monitored during charging by the temperature sensor 252. No electrical power can flow to the first connection port 202.

In another example, as shown in FIG. 4, the device 100 and the external power source 106 are both connected to the charging case 200 via the first connection port 202 and the second connection port 204 respectively. The MCU 224 detects that the device 100 is connected to the first connection port 202 via the monitoring line 272 and that the external power source 106 is connected to the second connection port 204 via the monitoring line 270. Electrical power from the external power source 206 can be provided to the internal battery 210 or the battery 106 of the device 100 or both.

The MCU 224 prioritizes charging the battery 106 of the device 100 over charging the internal battery 210 of the charging case 200.

In one example, the MCU 224 determines that the battery 106 of the device 100 is under charged and that the internal battery 210 is under charged but that the power available from the external power source 106 is sufficient only to meet the charging requirements of the battery 106 of the device 100. For example, the battery 106 of the device 100 may require a certain minimum supply voltage, e.g. 5V, for charging and the power source 106 can supply 5V. In this scenario, the MCU 224 configures the first switch 220 and second switch 222 to both be in an ON state via switch control lines 274 and 276 and the charging IC 226 to be OFF. Accordingly, in this scenario, electrical power is provided from the external power source 206 through a path defined by the second connection port 204, the first switch 220, second switch 222 and first connection port 202 to the device 100 and charges the battery 106 of the device 100 and no electrical power is supplied to the internal battery 210 As mentioned above, the device 100 will comprise its own charging integrated circuit (not shown) for regulating the charging of the battery 106 of the device 100 when power is provided in this way from the external power source 206 and so, in these circumstances, the charging of the battery 106 of the device 100, is under the control of the device's 100 own charging integrated circuit (not shown) and not the IC 226.

The MCU 224 monitors the charge status of the battery 106 of the device 100 to determine when the battery 106 of the device 100 reaches a predetermined charge level, for example, fully charged and no longer requires electrical power to be supplied to it. In response to this determination being made, the MCU 224 configures the second switch 222 into an OFF state while maintaining the first switch 220 in the ON state, and switches the charging IC 226 ON to enable power to be provided from the power source 106 via charging IC 226 to charge the internal battery 210. The voltage of the internal battery 210 is monitored by the MCU 224 over the monitoring line 290. As is standard with such components, the charging IC 226 controls the current that charges internal battery 210 based on the input voltage to charging IC 226 (e.g. if the input voltage drops then the charging current is reduced).

The prioritized charging of the battery 106 of the device 100 over the internal battery 210 prevents scenarios in which the internal battery 210 is being charged and the device 100 is not being charged. If a user connects the charging case 200 to an external power source 206 in order to charge its internal battery 210 and then subsequently connects the device 100 to the charging case 200 to charge the battery 106 of the device 100, the MCU 224 detects that the device 100 is now connected and that its battery 106 requires charging. In response to this, as described above, the MCU 224 configures the first switch 220 and the second switch 222 in an ON state and the charging IC 226 in an OFF state to prevent power being provided to the internal battery 210. In this way, power is directed from the external power source 206 to the battery 106 of the device 100 rather than to the internal battery 210 of the charging case 200.

In another example, the MCU 224 determines that the power available from the external power source 206 is sufficient to meet the charging requirements of the battery 106 of the device 100 and the internal battery 210 at the same time. For example, the external power source 206 may supply 20V whereas the battery of the device 100 only requires a supply voltage of 5V for charging. In this scenario, the MCU 224 configures the first switch 220 and second switch 222 to both be in an ON state via the switch control lines 274 and 276 respectively and the charging IC 226 to be switched ON. Accordingly, the battery 106 of the device 100 and the internal battery 210 are charged by the external power source 206 simultaneously. The MCU 224 and Charging IC 226 monitor the voltage of the internal battery 210 via monitoring line 290 to prevent overload. The charging IC 226 maintains the internal battery 210 charging current as high as possible to minimize the charging time.

FIG. 6 is a schematic diagram illustrating the internal components of a charging case 300 according to a second example. For brevity, components that are the same as or equivalent to components of the charging case 200 described above with reference to FIG. 5 have the same reference numerals as used in FIG. 5 but increased by 100.

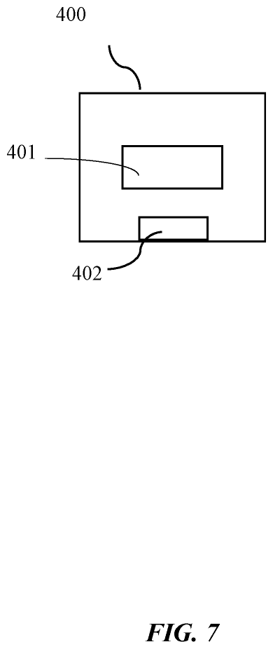

In this example, the charging case 300 comprises a device detection unit 392 which is arranged to detect when a device, such as the device 100, is connected to the first connection port 302. An example of the device detection unit 392 is described below in more detail in relation to FIG. 7.

The MCU 324 is connected to the second connection port 304 via a monitoring line 383 and uses the monitoring line 383 to detect that a device or external power source is connected to the second connection port 304.

The MCU 324 is connected to the first connection port 302 via a data line 385 and uses the data line 385 to receive data from or transmit data to the device 100 when the device 100 is connected to the first connection port 302.

The charging case 300 comprises an input protection unit 399 for protecting the Charging IC 326.

The charging case 300 also comprises a fuel gauge 394 that is in series with an electrical connection 396 between the internal battery 310 and the charging IC 326. The fuel gauge 394 measures the electrical energy going into or taken out of the internal battery 310 by measuring the current and voltage of the internal battery 310.

In this example, the control circuitry 308 comprises a first switch 320, a second switch 322, and a third switch 398 which are controlled by the MCU 324 via a switch control lines 374a (there is control line for each switch although for simplicity only a single line is shown in FIG. 6).

In a first example, the device 100 is connected to the first connection port 302 of the charging case 300, the battery 106 of the device 100 is under charged and the second connection port 304 is not in use (i.e. not active). In this scenario, the MCU 324 detects via the device detection unit 392 that the device 100 is connected to the charging case 300 and determines via the monitoring line 383 and/or the monitoring line 372 that the second connection port 304 is not in use. The MCU 324 configures the first switch 320 and the second switch 332 to both be in an OFF state and the third switch 398 to be in an ON state. With the switches in this configuration, electrical power stored in the internal battery 310 is provided vis the charging IC 326 and the first connection port 302 to charge the battery 106 of the device 100. No electrical power can flow to the second connection port 304.

In a second example, an external power source 206 is connected to the charging case 300 via the second connection port 304 and the internal battery 310 is under charged and the first connection port 302 is not in use. In this scenario, the MCU 324 detects via the monitoring line 383 and/or monitoring line 372 that the external power source 206 is connected to the second connection port 304 and detects via the device detection unit 392 that the device 100 is not connected to the charging case 300. The MCU 324 configures the first switch 320 to be in an ON state and the second switch 322 and the third switch 398 to both be in an OFF state. With the switches in this configuration, electrical power is provided from the external power source 206 via the charging IC 326 to charge the internal battery 310.

In a third example, a non—power source device 400, an example of which is schematically illustrated in FIG. 7, is connected to the charging case 300 via the second connection port 304. The non-power source device 400 comprises its own internal battery 401 and a connection port 402, similar to the connection ports described above, for making the connection to the second connection port 304.

The non-power source devices may, for example, be a camera, mobile telephones, a GPS devices or the like.

In this example, the first connection port 302 is not in use. In this scenario, the MCU 324 detects via the monitoring line 383 and/or monitoring line 372 that a non—power source device 400 is connected to the second connection port 304 and detects via the device detection unit 392 that the device 100 is not connected to the charging case 300. The MCU 324 configures the first switch 320 to be in an ON state and the second switch 322 and the third switch 398 to both be in an OFF state. With the switches in this configuration, electrical power from the internal battery 310 is provided via the charging IC 326 to charge the internal battery 401 of the non—power source device 400.

In a fourth example, the device 100 and the non—power source device 400 are both connected to the charging case 300 via the first connection port 302 and the second connection port 304 respectively. The MCU 324 detects that the device 100 is connected to the first connection port 302 via the device detection unit 392 and that the non-power source device 400 is connected to the second connection port 304 via the monitoring line 383 and/or monitoring line 372.

The MCU 324 prioritizes charging the battery 106 of the device 100 over charging the battery 401 of the non—power source device 400.

In this example, the MCU 324 configures the first switch 320 and the second switch 322 to be in OFF state and the third switch 398 to be in an ON state. Accordingly, electrical power is provided from the internal battery 310 via a path including the charging IC 326, the third switch 322 and first connection port 302 to charge the battery 106 of the device 100.

The MCU 324 monitors the charge status of the battery 106 of the device 100 to determine when the battery 106 of the device 100 reaches a predetermined charge level, for example fully charged, and no longer requires electrical power to be supplied to it. In response to this determination being made, the MCU 324 configures the first switch 320 into an ON state, the third switch 398 into an OFF state and maintains the second switch 322 in an OFF state. With the switches in this configuration, power is provided from the internal battery 310 through a path including the charging IC 326, the first switch 320 and the second connection port 302 to charge the battery 401 of the non-power source device 400.

In some examples, simultaneous charging of both the battery 401 of the non power source 400 device and the battery 106 of the device 100 will occur if there is sufficient electrical power available from the internal battery 310. That is to say, the battery 106 of the device 100 is being charged at full capacity and the internal battery 310 is able to provide additional power to charge the battery 401 of the device 400.

In a fifth example, the device 100 and the external power source 106 are both connected to the charging case 300 via the first connection port 302 and the second connection port 304 respectively. The MCU 324 detects that the device 100 is connected to the first connection port 202 via the device detection unit 392 and that the external power source 106 is connected to the second connection port 304 via the monitoring line 383 and/or monitoring line 370.

The MCU 324 prioritizes charging the battery 106 of the device 100 over charging the internal battery 310.

In one scenario, the MCU 324 determines that the battery 106 of the device 100 is under charged and that the internal battery 310 is under charged but that the power available from the power source 106 is sufficient only to meet the charging requirements of the battery 106 of the device 100. For example, the battery 106 of the device 100 may require a certain minimum supply voltage, e.g. 5V for charging, and the power source 106 can only supply 5V. In this scenario, the MCU 324 configures the first switch 320 and the third switch 398 to be in OFF state and the second switch 322 to be in an ON state. Accordingly, in this scenario, electrical power is provided from the external power source 106 through a path including by the second connection port 304, the second switch 322 and first connection port 302 to charge the battery 106 of the device 100.

The MCU 324 monitors the charge status of the battery 106 of the device 100 to determine when the battery 106 of the device 100 reaches a predetermined charge level, for example fully charged, and no longer requires electrical power to be supplied to it. In response to this determination being made, the MCU 324 configures the first switch 320 into an ON state and the second switch 322 into an OFF state while maintaining the third switch 398 in an OFF state. With the switches in this configuration, power is provided from the power source 106 to charge the internal battery 310 and no power is provided to the device 100.

In an alternative scenario, the MCU 324 determines that the battery of the device 100 and the internal battery 310 are under charged and that the power available from the external power source 206 is sufficient to meet the charging requirements of both simultaneously. In this scenario, the MCU 324 configures the first switch 320 and second switch 322 to both be in an ON state and the third switch 398 to be in an OFF state. With the switches in this configuration, power is provided from the power source 106 to charge the internal battery 210 and the battery 106 of the device 100 simultaneously.

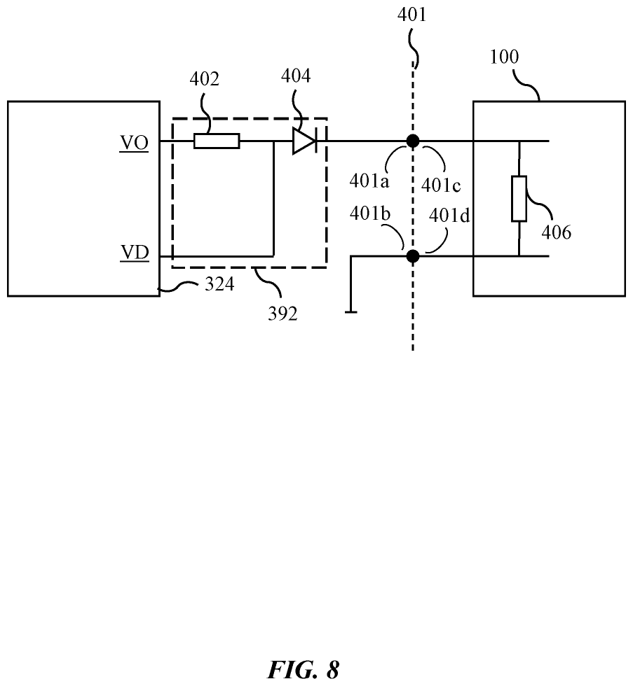

FIG. 8 is a schematic illustration of the MCU 324 and the device detection unit 392 (represented by the dashed box) of a charging case 300 as described above and the device 100. The dashed line 401 represents a bespoke connection interface between the charging case 300 and the device 100 when the device 100 is connected to the charging case 300. In this example, the first connection port 302 defines the charging case 300 side of the connection interface 401.

The MCU 34 comprises a voltage output pin VO and a voltage detection pin VD. The device detection unit 392 comprises a resistor 402, a diode 404 and first 401a and second 402b contacts. A first end of the resistor 402 is connected to the Voltage output pin VO and a second end of the resistor 402 is connected to the voltage detection pin VD and an anode of the diode 404. A cathode of the diode 404 is connected to the first contact 401a. The second contact 401b is connected to ground.

The device 100 comprises third 401c and fourth 401d electrical contacts and a resistor 406 connected across the third 401c and the fourth 401d electrical contacts.

When the device 100 is connected to the charging case 300, the first electrical contact 401a contacts the third electrical contact 401c and the second electrical contact 401b contacts the fourth electrical contact 401d.

In use, the Voltage output pin VO of the MCU 324 outputs a small fixed voltage and the MCU 324 monitors for a detection voltage level at the detection pin VD.

When the device 100 is connected to the charging case 300, the resistor 402 and the resistor 406 form a potential divider and so the voltage level at the detection pin VD drops to a predetermined detection voltage which is detected by the MCU 324

The reduction in voltage that the MCU 324 detects when the device 100 is connected to the charging case will be determined by the two resistances of the resistors 402 and 406. Accordingly, knowing the two resistances will allow the MCU to identify if the device 100 is connected or a different, un-compatible device. Therefore, it can be envisaged that if an un-compatible device having a different internal resistance/resistor is connected, the MCU 324 will be able to identify this and prevent the +5V supply 408.

In other examples, the connection interface is not bespoke but instead is defined by standard connector types e.g. Type C USB connectors. In these examples, the MCU 324 may again detect that a device 100 has been connected to the charging case by detecting a high level signal to an output power connector in the interface dropping to a low level signal when the device 100 is connected to the carry case.

The charging case 300 may comprises alternative arrangements to detect when the device 100 is connected, for example, a Hall or a mechanical switch.

In the illustrated examples above, the first electrical connection ports 202 and 302 are bespoke two pin connection ports. Alternatively, the first electrical connection port 202, 302 may be a standard pin connection port, for example, USB type C, or micro-USB or the like. Although in the above examples the first connection ports 202, 302 and second connection ports 204, 304 are described as being pin connectors, it will be appreciated that alternate connection ports may be used to transfer power and/or data into and out of the device. For example, wireless connection ports, wireless charging systems and the like.

The above embodiments are to be understood as illustrative examples of the disclosure. Further embodiments of the disclosure are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A non-combustible aerosol provision system comprising:
a non-combustible aerosol provision device comprising a first rechargeable battery; and
a charging apparatus for use with the non-combustible aerosol provision device and comprising:
a housing,
a second rechargeable battery disposed within the housing,
a first electrical connection port for connecting to the non-combustible aerosol provision device,
a second electrical connection port for connecting to an external power source, and
control circuitry,
wherein, in use, when the external power source is connected to the second electrical connection port and the non-combustible aerosol provision device is connected to the first electrical connection port, the control circuitry prioritizes directing electrical power from the external power source to the non-combustible aerosol provision device to charge the first rechargeable battery over directing electrical power from the external power source to charge the second rechargeable battery.

2. The non-combustible aerosol provision system according to claim 1, wherein, when the external power source is connected to the second electrical connection port and the non-combustible aerosol provision device is connected to the first electrical connection port, the control circuitry prioritizes directing electrical power from the external power source to charge the first rechargeable battery until a charge level of the first rechargeable battery reaches a pre-determined charge level whereafter the control circuitry is configured to direct electrical power from the external power source to charge the second rechargeable battery.

3. The non-combustible aerosol provision system according to claim 2, wherein the pre-determined charge level is fully charged.

4. The non-combustible aerosol provision system according to claim 1, wherein, when the external power source is connected to the second electrical connection port and the non-combustible aerosol provision device is connected to the first electrical connection port, the control circuitry determines whether the external power source has sufficient power to charge the second rechargeable battery and the first rechargeable battery simultaneously and if the control circuitry determines that the external power source has insufficient power to charge the second rechargeable battery and the first rechargeable battery simultaneously, the control circuitry is configured to direct power from the external power source to the non-combustible aerosol provision device to charge the first rechargeable battery only.

5. The non-combustible aerosol provision system according to claim 4, wherein, if the control circuitry determines that the external power source has sufficient power to charge the second rechargeable battery and the first rechargeable battery simultaneously, the control circuitry is configured to direct power from the external power source to charge the first rechargeable battery and to charge the second re-chargeable battery simultaneously.

6. The non-combustible aerosol provision system according to claim 1, wherein, the control circuitry is configured to direct electrical power from the external power source to charge the second rechargeable battery when the external power source is connected to the second electrical connection port and the first electrical connection port is inactive.

7. The non-combustible aerosol provision system according to claim 1, wherein the second electrical connection port is also for connecting to a non-power source device, and wherein the control circuitry is configured to direct electrical power from the second rechargeable battery to charge a rechargeable battery of the non-power source device when the non-power source device is connected to the second electrical connection port and the first electrical connection port is inactive.

8. The non-combustible aerosol provision system according to claim 1, wherein the second electrical connection port is also for connecting to a non-power source device, and wherein, when the first electrical connection port is connected to the non-combustible aerosol provision device and the second electrical connection port is connected to the non-power source device, the control circuitry is configured to prioritize directing electrical power from the second rechargeable battery to charge the first rechargeable battery over directing electrical power from the first rechargeable battery to charge a rechargeable battery of the non-power source device.

9. The non-combustible aerosol provision system according to claim 8, wherein, when the non-power source device is connected to the second electrical connection port and the non-combustible aerosol provision device is connected to the first electrical connection port, the control circuitry prioritizes directing electrical power from the second rechargeable battery to charge the first rechargeable battery until a charge level of the first rechargeable battery reaches a pre-determined charge level whereafter the control circuitry is configured to direct electrical power from the second rechargeable battery to charge the rechargeable battery of the non-power source device.

10. The non-combustible aerosol provision system according to claim 1, wherein the control circuitry is configured to direct electrical power from the second rechargeable battery to charge the first rechargeable battery when the non-combustible aerosol provision device is connected to the first electrical connection port and the second electrical connection port is inactive.

11. The non-combustible aerosol provision system according to claim 1, wherein the control circuitry comprises a controller and a plurality of switches controlled by the controller, and wherein the controller configures the plurality of switches in any one of a plurality of different selectable ON/OFF state configurations in order to direct power through the charging apparatus.

12. The non-combustible aerosol provision system according to claim 11, wherein, in use, the controller configures the plurality of switches in a first one of the plurality of different selectable ON/OFF state configurations in order to direct power from at least one of:
a power supply connected to the second electrical connection port to charge the second rechargeable battery, or
the external power source to charge the first rechargeable battery when the non-combustible aerosol provision device is connected to the first electrical connection port.

13. The non-combustible aerosol provision system according to claim 12, wherein, in use, the controller configures the plurality of switches in a selected second one of the plurality of different selectable ON/OFF state configurations in order to direct power from the second rechargeable battery to charge the first rechargeable battery when the non-combustible aerosol provision device is connected to the a first electrical connection port.

14. The non-combustible aerosol provision system according to claim 1, further comprising one or more indicators arranged to indicate a charge status of the first rechargeable battery.

15. The non-combustible aerosol provision system according to claim 14, wherein the one or more indicators comprises one or more light emitting diodes.

16. The non-combustible aerosol provision system according to claim 1, wherein the charging apparatus is a portable carry case for storing the non-combustible aerosol provision device.

17. A charging apparatus for use in the non-combustible aerosol provision system of claim 1.

18. A kit of parts comprising the charging apparatus of claim 17 and the non-combustible aerosol provision device for connecting to the first connection port.
